(19) United States
(12) Patent Application Publication
(10) Pub. No.: US 2014/0378289 A1
(43) Pub. Date: Dec. 25, 2014

(54) Oil Cleaning Device of an Engine Oil Circuit

(71) Applicants: Marco Schweikart, Marbach (DE); Martin Weindorf, Kornwestheim (DE)

(72) Inventors: Marco Schweikart, Marbach (DE); Martin Weindorf, Kornwestheim (DE)

(21) Appl. No.: 14/484,877

(22) Filed: Sep. 12, 2014

Related U.S. Application Data
(63) Continuation of application No. PCT/EP2013/051176, filed on Jan. 23, 2013.

(30) Foreign Application Priority Data
Mar. 12, 2012 (DE) 10 2012 004 672.3

(51) Int. Cl. F01M 11/03; B04B 15/02; B04B 7/18; B04B 11/00

(52) U.S. Cl. CPC F01M 11/03; B04B 11/00; B04B 15/02; B04B 7/18
USPC 494/14; 494/56; 494/36

(57) ABSTRACT

An oil cleaning device of an engine oil circuit has a centrifuge that removes particles from oil. The centrifuge has a centrifuge housing with an inlet for the oil to be cleaned and a drain for the cleaned oil. The centrifuge housing has a housing cup and a housing cover detachably connected to the housing cup. A rotor is rotatably arranged inside the centrifuge housing. The housing cover, in a mounted state of the centrifuge, closes off a bottom end of the housing cup. The drain extends through a circumferential wall of the housing cup and has a drain opening provided in a radial inner circumferential side of the circumferential wall. The drain opening has a lower boundary at the radial inner circumferential side. The housing cover has a topside with a radial outer rim arranged at the level of or above the lower boundary of the drain opening.

### CROSS-REFERENCE TO RELATED APPLICATIONS

This application is a continuation application of international application No. PCT/EP2013/051176 having an international filing date of 23 Jan. 2013 and designating the United States, the International Application claiming a priority date of 12 Mar. 2012, based on prior filed German patent application No. 10 201 2 004 672.3, the entire contents of the aforesaid international application and the aforesaid German patent application being incorporated herein by reference.

### BACKGROUND OF THE INVENTION

The invention concerns an oil cleaning device of an engine oil circuit of an internal combustion engine, in particular of a motor vehicle, comprising a centrifuge for removal of particles from the oil. The centrifuge comprises a centrifuge housing which comprises at least one inlet for the oil to be freed from particles and at least one drain for the oil that has been freed from particles and which further comprises a housing cup that is provided with a separable housing cover and in which a rotor is arranged so as to be rotatable about an axis of rotation axis.

A centrifuge known in the market is arranged in an engine oil circuit of an internal combustion engine. It serves for removal of particles, in particular dirt, from the engine oil. The centrifuge comprises a centrifuge housing into which an inlet for the oil to be freed from particles is extended. The inlet is connected to a radial inner area of a rotor that is arranged, rotatable about an axis of rotation, in the centrifuge housing. The oil to be cleaned passes from the inlet into the interior of the rotor. Due to the rotation of the rotor, the particles are separated on corresponding baffles plates of the rotor and are collected in a collecting area. The oil that has been freed from particles is collected in a bottom area of the centrifuge housing. It exits through a drain from the centrifuge housing and is returned to the engine oil circuit. The centrifuge housing comprises a housing cup which is closed off by a separable housing cover. In the mounted state of the centrifuge, the housing cover is spatially at the top. For servicing purposes, in particular for exchanging or for cleaning the rotor, the housing cover can be opened and the rotor can be removed from the housing cup from above. When the centrifuge is installed, it may happen that, for spatial reasons, the topside of the housing cup is difficult to access or not at all accessible. In order to remove the rotor, it may be necessary in this case to separate the centrifuge housing from the engine oil circuit.

The invention has the object to design an oil cleaning device of the aforementioned kind such that it is of a configuration as simple as possible and enables access as easily as possible to the rotor, in particular removal and installation as easily as possible. Preferably, the rotor should also be easily accessible when the centrifuge, in the mounted state, is not accessible or only accessible with difficulty from above.

### SUMMARY OF THE INVENTION

This object is solved according to the invention in that the housing cover in the mounted state of the centrifuge closes off the housing cup spatially at the bottom end (downwardly pointing end), in that the drain is extending through a circumferential wall of the housing cup, and in that the topside of the housing cover at its radial outer rim is arranged approximately at the level of or above a lower boundary of a drain opening of the drain provided in the radial inner circumferential side of the circumferential wall of the housing cup.

According to the invention, a mounting opening of the centrifuge housing is spatially at the bottom end (downwardly pointing end) and is closed off by a removable housing cover. The housing cover forms in this way the bottom of the centrifuge housing at least partially. In this way, the mounting opening of the centrifuge housing can be accessed from below. The centrifuge can thus be serviced from below. In this way, the centrifuge can also be serviced easily in those installation situations where, as a result of the installation space, the access from above is difficult or blocked. Advantageously, the rotor can be removed from the centrifuge housing from below through the mounting opening. The drain extends through the circumferential wall into the interior of the centrifuge housing. A separate drain conduit on the housing cover is thus not needed. This saves space and materials. Also, the mounting expenditure can be reduced in this way.

The drain may advantageously open directly above the housing cover, i.e., in the vicinity of the bottom of the centrifuge housing, into the interior of the centrifuge housing. In this way, oil which collects at the bottom of the centrifuge housing can easily drain. In this way, it can be prevented that, upon removal of the housing cover, oil can escape through the mounting opening of the housing cup into the environment.

Advantageously, the topside of the housing cover can pass into a lower boundary surface of the drain in such a way that oil from areas that are located radially within the outer rim of the topside of the housing cover and that are positioned higher than the outer rim of the topside of the housing cover itself, can flow into the drain. In this way, oil which cannot be retained radially inward by a possible circumferential rim at the topside of the housing cover can flow out via the drain. The topside of the housing cover at the radial outer rim can be arranged preferably maximally approximately 5 mm, preferably less than 1 mm, below the lower boundary of the opening of the drain. Preferably, the topside of the housing cover can be arranged at the radial outer rim at the level or above the lower boundary. Advantageously, at least the radial inner side of the circumferential wall of the housing cup, the rotor, and the housing cover can be coaxial to the rotor axis. Moreover, advantageously the housing cover can be of rotational symmetry. In this way, mounting can be simplified. In particular, positioning aids are not needed. Advantageously, the axis of rotation may be extending vertically in the mounted state of the centrifuge. Moreover, the rotor can be advantageously supported at an end face on the housing cover so as to be rotatable about the axis of rotation. In this way, a separate bearing is not needed.

In other respects, the housing cover can be advantageously connected detachably on the housing cup by means of a rotary and/or plug-in connection, in particular, a screw connection or a bayonet-like connection. Rotary and/or plug-in connections can be closed and separated again in a simple way. They can also be realized in a space-saving way. The housing cover can advantageously be mounted in an appropriate receiving area of the housing cup. Alternatively, the housing cover can be mounted on the housing cup.

Advantageously, a drain opening of the drain can extend to the interior of the centrifuge housing, in the direction toward the axis of rotation, across outlet openings for the purified oil which lead out of a housing of the rotor. In this way, the purified oil which is flowing out of the rotor housing can drain even better.

Advantageously, the oil cleaning device can be arranged in the area of an oil pan of the internal combustion engine. It can be arranged in an especially space-saving manner within the oil pan. The oil cleaning device can be advantageously of a modular design. In this way, it can be easily connected in a pre-assembled state with the engine oil circuit.

In an advantageous embodiment, between the topside of the housing cover and the drain a slope can be provided by means of which the oil, which is collecting at the topside of the housing cover at the radial inner circumferential side of the circumferential wall of the housing cup, can drain. The slope between the topside of the housing cover and the drain enables that as much as possible of the oil which is located on the topside of the housing cover can exit from the centrifuge housing through the drain. In order to be able to realize in a simple way a slope between the topside of the housing cover and the drain, the drain can preferably be positioned spatially below the topside of the housing cover.

In a further advantageous embodiment, the topside of the housing cover can be convexly shaped when viewed from the interior of the housing cup. In this way, the oil can flow on the topside of the housing cover radially in outward direction, can collect in the area of the radial outer rim, and flow out through the drain opening. In this way, the quantity of oil which remains on the topside of the housing cover can be further reduced.

Advantageously, the drain can be connected with an oil sump of the internal combustion engine. The oil that is freed from particles can thus be returned directly through the drain to the oil sump.

In a further advantageous embodiment, the oil cleaning device may comprise at least one oil cooler and/or at least one oil filter which can be connected fluidically with the centrifuge. By means of an oil filter, the oil can be filtered additionally. The oil filter can be arranged fluidically upstream or downstream of the centrifuge. It may be a coarse filter or a fine filter. By means of the oil cooler, the oil can be cooled. The centrifuge can form in a simple way a space-saving unit together with the oil cooler and/or the oil filter. Advantageously, the oil cleaning device can be of a modular design. Depending on the application, the centrifuge can be combined with an oil cooler or with an oil filter or with both. The oil cleaning device, preassembled in this way, can be simply connected with the engine oil circuit.

### BRIEF DESCRIPTION OF THE DRAWINGS

Further advantages, features, and details of the invention result from the following description in which an embodiment of the invention will be explained in more detail with the aid of the drawing. A person of skill in the art will expediently consider the features disclosed in combination in the drawing, the description, and the claims also individually and combine them to other meaningful combinations.

FIG. 1 shows schematically a section of a centrifuge for removal of particles from the oil of an engine oil circuit of an internal combustion engine, wherein an axis of rotation of a rotor of the centrifuge is located in the section plane.

FIG. 2 shows schematically a section of the centrifuge of FIG. 1 along a second section plane along the centerline of the inlet, viewed in opposite viewing direction.

In the Figures, same components are provided with same reference characters.

### DESCRIPTION OF PREFERRED EMBODIMENTS

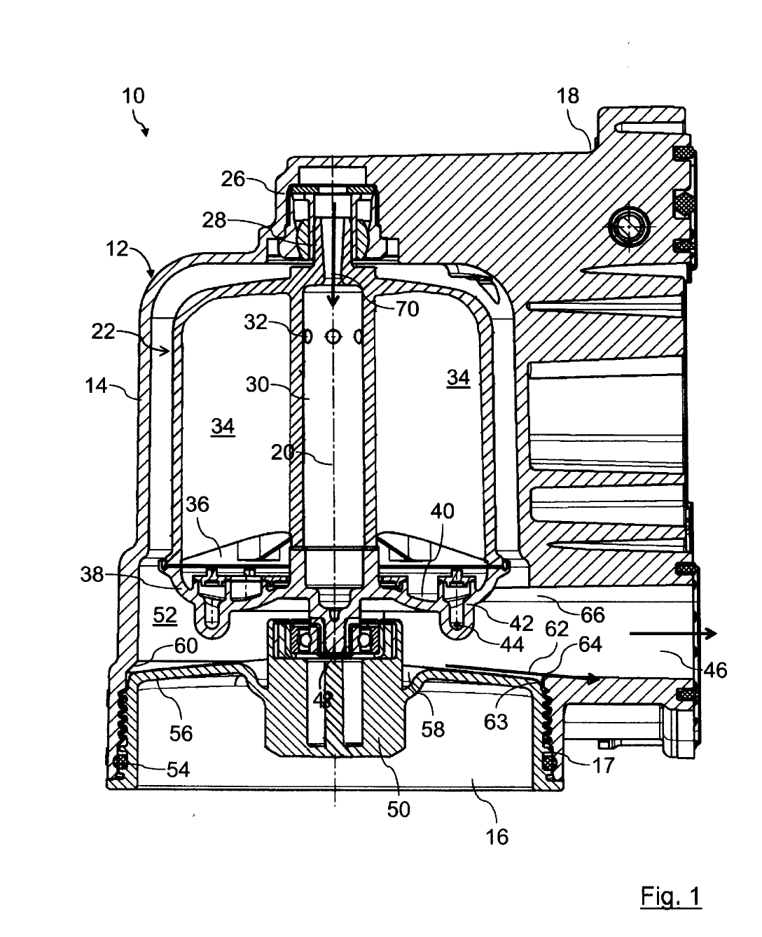

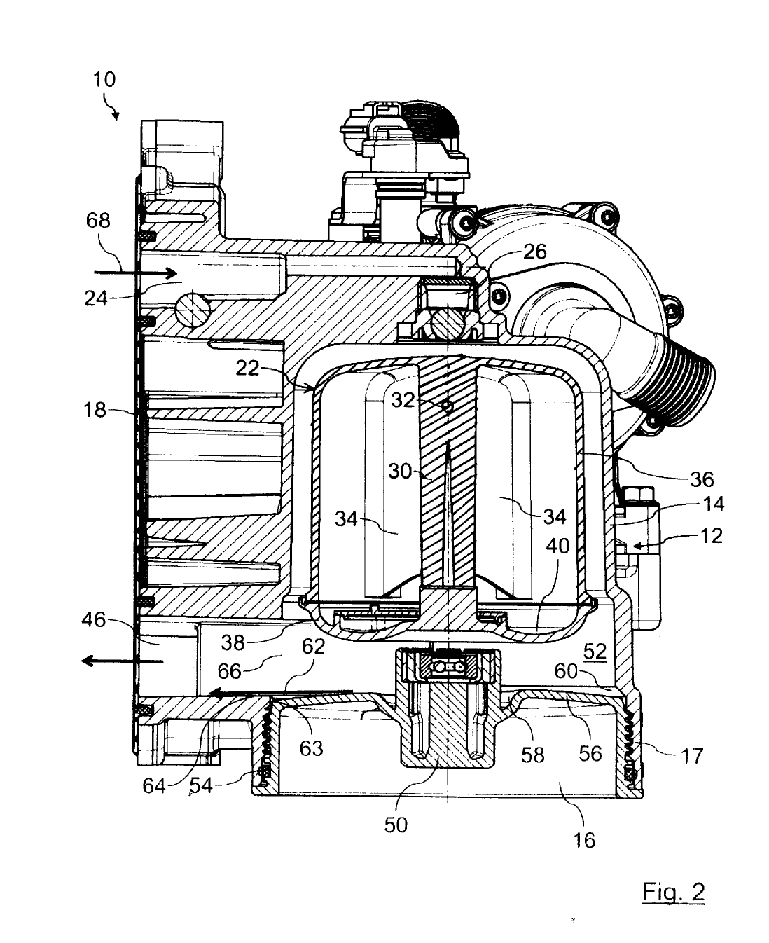

In FIG. 1, a centrifuge 10 is shown in section along a first section plane. An axis of rotation 20 of the rotor 22 of the centrifuge 10 is positioned in the first section plane. FIG. 2 shows the centrifuge 10 in a section along a second section plane. The second section plane extends parallel to the first section plane of FIG. 1. A viewing direction in FIG. 1 is oriented opposite to a viewing direction of FIG. 2. The centrifuge 10 is arranged in an engine oil circuit, not shown herein, of an internal combustion engine of a motor vehicle. It serves for removal of particles contained in the engine oil, for example, dirt. The centrifuge 10 as a whole is of a modular configuration. It is preassembled and connected with the engine oil circuit upon final assembly of the internal combustion engine. The centrifuge 10 is arranged in an oil pan, not shown herein, of the internal combustion engine.

The centrifuge 10 comprises a centrifuge housing 12 with a housing cup 14 and a housing cover 16. In the mounted state of the centrifuge 10 illustrated in FIGS. 1 and 2, a mounting opening 17 of the housing cup 14 is arranged spatially at the bottom end (downwardly pointing end). The housing cover 16 is installed from below in the mounting opening 17.

At a radial outer circumferential side, the housing cup 14 is connected monolithically with a connecting flange 18. With the connecting flange 18, the centrifuge 10 is fastened in a way not of interest in this context to a connecting flange, not shown, of the engine oil circuit. The radial inner circumferential side of the housing cup 14 and the housing cover 16 are arranged coaxially to the axis of rotation 20.

An inlet 24, illustrated in FIG. 2, is passing through the connecting flange 18 into an interior of a bearing receptacle 26 for the rotor 22. At the other end, the inlet 24 is connected with an inlet line, not illustrated in FIGS. 1 and 2, of the engine oil circuit. By means of the inlet 24, the engine oil to be freed from particles is supplied to the centrifuge 10. The bearing receptacle 26 is located at the top in the housing cup 14. It is a multi-stepped blind bore that, as a whole, is circular-cylindrical and extends coaxially to the axis of rotation 20.

A top pin 28, coaxial to the axis of rotation 20, of the rotor 22 is rotatably supported in the bearing receptacle 26. The top pin 28 has a hollow interior. Through the top pin 28, a fluid connection axial to the axis of rotation 20 extends from the interior of the bearing receptacle 26 into an interior of the central tube 30 of the rotor 22. In an upper area of its circumferential wall, the central tube 30 comprises a plurality of outlet openings 32 for the supplied engine oil. From the radial outer circumferential side of the central tube 30, a plurality of baffle plates 34 extend to a circumferential wall 36, illustrated in FIG. 2, of the rotor 22. The baffle plates 34 are arranged approximately in a star shape. They extend relative to the axis of rotation 20 in radial direction and in axial direction. A rotor bottom 38 of the rotor 22 has a circumferentially extending depression 40 relative to the axis of rotation 20. A plurality of nozzles 42 passes from a rotor interior of the rotor 22 through the rotor bottom 38 to the rotor exterior. The rotor interior is delimited by the circumferential wall 36, the rotor bottom 38, and by a cover on the side opposite the rotor bottom 38. The openings of the nozzles 42 located within the rotor interior are arranged at a spacing above the bottom of the depression 40. At its lower end, each nozzle 42 has a nozzle opening 44 at the outer bottom side of the rotor 22 facing away from the rotor interior. The nozzle openings 44 are oriented such that a repulsion of the engine oil exiting through them can drive the rotor 22 to perform rotation about the axis of rotation 20.

Spatially below the rotor bottom 38, approximately at the level of the nozzles 42, a drain 46 passes through the circumferential wall of the housing cup 14 out of the centrifuge housing 12. The drain 46 extends through the connecting flange 18 and is connected by means of a return line, not illustrated in FIGS. 1 and 2, with an oil sump of the internal combustion engine. Through the drain 46 and the return line, engine oil that has been freed from particles can pass from the centrifuge housing 12 into the oil sump.

On the outer bottom side of the rotor bottom 38 facing away from the rotor interior, a lower bearing pin 48 is arranged coaxially to the axis of rotation 20 on the exterior. The lower bearing pin 48 is monolithically connected with the rotor bottom 38. The lower bearing pin 48 is supported, rotatable about the axis of rotation 20, in a receiving section 50 attached to the housing.

As a whole, the approximately cup-shaped housing cover 16 is of rotational symmetry relative to the axis of rotation 20. An open end face of a circumferential wall of the housing cover 16 is positioned at the lower end, i.e., on the outer bottom side of the centrifuge housing 12 facing away from the interior 52 of the housing cup 14. The radial outer circumferential side of the circumferential wall is provided with an outer thread with which the housing cover 16 is screwed into an appropriate inner thread of the housing cup 14. Moreover, in the area of the free edge of the circumferential wall, a seal 54 in the form of an O-ring seal is arranged radially in outward direction. Bottom 56 of the cup-shaped housing cover 16 forms a bottom of the centrifuge housing 12.

The receiving section 50 is arranged at the center of the bottom 56. It is monolithically connected with the bottom 56. Radially in outward direction, at the transition of the receiving section 50 into the bottom 56, depression 58 extending circumferentially relative to the axis of rotation 20 is formed. Radially outside of the depression 58, the topside of the bottom 56 facing the interior 52 is convexly formed, when viewed from above, i.e., viewed from the interior 52. Between the topside of the bottom 56 and a bottom side of the drain 46 there is a slope by means of which the oil which is located on the topside of the housing cover 16, i.e., on the bottom 56, can drain. The slope is illustrated in FIG. 1 by arrow 62. It is oriented relative to the axis of rotation 20 from a radial inner upper point to a radial outer lower point. Relative to the axis of rotation 20, a drain opening 66 of the drain 46 extends circumferentially approximately about half the circumference of the housing cup 14. A radial outer rim 63 of the topside of the bottom 56 facing the interior 52 is located approximately at the level of a lower boundary 64 of the drain opening 66.

Upon operation of the internal combustion engine, the engine oil that is to be freed from particles flows under pressure from the inflow line of the engine oil circuit through the inlet 24 into the interior of the bearing receptacle 26, indicated in FIG. 2 by arrow 68. From here, the engine oil flows through the upper bearing pin 28 into the central tube 30, indicated in FIG. 1 by arrow 70. The engine oil exits through the outlet openings 32. The particles contained in the engine oil are separated in the rotor interior from the engine oil, as will be explained in more detail below. The engine oil freed from particles passes downwardly into the nozzles 42 and is sprayed through the nozzle openings 44 in outward direction. Due to the repulsion caused thereby, the rotor 22 is driven to perform a rotation about axis of rotation 20. This rotation has the effect that, as a result of centrifugal forces, the particles are separated at the baffle plates 34 and the circumferential wall 36 of the rotor 22. The particles sink downward and collect in the depression 40.

The engine oil which is flowing out of the nozzles 42 and is freed from particles collects below in the interior 52 of the housing cup 14 at the bottom 56. The oil flows as a result of the convex shape of the bottom 56 radially in outward direction and collects at the radial inner circumferential side 60 of the circumferential wall of the housing cup 14. From here, it flows to the drain opening 66. As a result of the slope 60, the engine oil flows into the drain 46. From the drain 46, the engine oil passes through the return line into the oil sump.

For servicing purposes, for example, for cleaning or exchanging the rotor 22, the housing cover 16 is unscrewed in downward direction from the housing cup 14. The rotor 22 can then be removed through the mounting opening 17 from the housing cup 14. The assembly is carried out in reverse order.

In the embodiment of a centrifuge 10 described above, the following modifications are possible inter alia.

The invention is not limited to an engine oil circuit of an internal combustion engine of a motor vehicle. Instead, it can be used also in other types of internal combustion engines, for example, industrial motors.

The centrifuge 10, instead of being arranged in the oil pan of the internal combustion engine, can also be arranged at a different location within the engine oil circuit.

The centrifuge 10 can also be connected with an oil filter and/or an oil cooler. The centrifuge 10 can be designed together with the oil filter and/or the oil cooler as an oil treatment module which, preassembled, can be arranged in the engine oil circuit, for example, in the oil pan.

The radial outer rim 63 of the bottom 56, i.e., of the housing cover 16, can be located also above the lower boundary 64 of the drain opening 66 of the outlet 46. The radial outer rim 63 can be located, for example, by at most 5 mm, preferably by at most 1 mm, slightly below the lower boundary 64 of the drain opening 66 of the drain 46.

The bottom 56 of the housing cover 16, instead of being formed convexly, can also be formed differently. For example, it can also be formed in a tub shape.

The outlet opening 66 of the drain 46 can also be circumferentially extending across less than or more than half of the radial inner circumference of the housing cup 14. The drain opening 66 can extend also in upward direction farther than up to the rotor bottom 38 of the rotor 22. The drain opening 66 can extend across the entire axial height of the interior 52 of the housing cup 14.

While specific embodiments of the invention have been shown and described in detail to illustrate the inventive principles, it will be understood that the invention may be embodied otherwise without departing from such principles.

What is claimed is:

1. An oil cleaning device of an engine oil circuit, the oil cleaning device comprising:
a centrifuge adapted to remove particles from oil;
the centrifuge comprising a centrifuge housing comprising at least one inlet for the oil to be freed from particles and at least one drain for the oil that has been freed from particles;
the centrifuge housing comprising a housing cup and a housing cover adapted to be detachably connected to the housing cup;
a rotor arranged in an interior of the centrifuge housing so as to be rotatable about an axis of rotation;
the housing cover, in a mounted state of the centrifuge, closing off a bottom end of the housing cup;
the at least one drain extending through a circumferential wall of the housing cup and comprising a drain opening provided in a radial inner circumferential side of the circumferential wall of the housing cup, wherein the drain opening comprises a lower boundary at the radial inner circumferential side
the housing cover having a topside provided with a radial outer rim;
the radial outer rim arranged approximately at the level of or above the lower boundary of the drain opening.

2. The oil cleaning device according to claim 1, wherein, between the topside of the housing cover and the drain, a slope is provided, wherein the slope causes the oil to collect on the topside of the housing cover at the radial inner circumferential side of the circumferential wall of the housing cup and drain into the at least one drain.

3. The oil cleaning device according to claim 1, wherein the topside of the housing cover, viewed from the interior of the housing cup, is convexly shaped.

4. The oil cleaning device according to claim 1, wherein the at least one drain is adapted to be connected to an oil sump of an internal combustion engine.

5. The oil cleaning device according to claim 1, further comprising an oil cooler connected fluidically to the centrifuge.

6. The oil cleaning device according to claim 1, further comprising an oil filter connected fluidically to the centrifuge.

7. The oil cleaning device according to claim 1, further comprising an oil cooler connected fluidically to the centrifuge and further comprising an oil filter connected fluidically to the centrifuge.
